(19) United States
(12) Patent Application Publication
(10) Pub. No.: US 2026/0122086 A1
(43) Pub. Date: Apr. 30, 2026

(54) SANDBOX SERVICE FOR DETECTING MALFORMED DOMAIN NAME SYSTEM PACKETS ON THE FLY

(71) Applicant: Palo Alto Networks, Inc., Santa Clara, CA (US)

(72) Inventors: Zhanhao Chen, Sunnyvale, CA (US); Daiping Liu, Santa Clara, CA (US); Fan Fei, Pleasanton, CA (US)

(21) Appl. No.: 18/933,571

(22) Filed: Oct. 31, 2024

(51) Int. Cl. H04L 9/40; H04L 61/00; H04L 61/4511

(52) U.S. Cl. CPC H04L 63/1425; H04L 61/35; H04L 61/4511; H04L 63/1416

(57) ABSTRACT

Network traffic associated with a domain name server (DNS) resolver is collected. Network traffic is simulated using a plurality of sandboxed DNS resolvers. A DNS-related attack on the DNS resolver is detected based on the corresponding outputs associated with the plurality of different sandboxed DNS resolvers.

### BACKGROUND OF THE INVENTION

Networks often deploy a Domain Name Service (DNS) system to facilitate network packet routing. A network's DNS system consists of one or more DNS servers which interoperate to receive a network packet addressed to a domain name, determine the domain name's corresponding Internet Protocol (IP) address, and return a DNS response containing the corresponding IP address to the original sender.

Malicious parties have developed methods to exploit security vulnerabilities in DNS systems. Many DNS exploits involve forwarding a malformed packet to a DNS server. When the DNS server receives and processes the malformed packet, the malformed packet can potentially exploit security vulnerabilities in the DNS system leading to various attacks on the network as a whole.

### BRIEF DESCRIPTION OF THE DRAWINGS

Various embodiments of the invention are disclosed in the following detailed description and the accompanying drawings.

FIG. 1 is a system diagram illustrating a client utilizing a Domain Name System (DNS).

FIG. 2 is a block diagram of a system to implement DNS on a network with enhanced security capabilities in accordance with some embodiments.

FIG. 3A is a flow diagram illustrating a process to collect real world DNS traffic data for future use in accordance with some embodiments.

FIG. 3B is a flow diagram illustrating a process to simulate DNS traffic data in accordance with some embodiments.

FIG. 3C is a flow diagram illustrating a process to enhance DNS security in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Systems and methods to enhance a network's security against Domain Name Service (DNS) related attacks are disclosed herein. The systems and methods disclosed herein allow a network to prevent exploits of vulnerabilities in the network's DNS. The systems and methods disclosed herein may be used to detect and prevent one or more attacks involving DNS.

A DNS system is comprised of one or more DNS servers which interoperate to resolve domain names to IP addresses. A DNS server is implemented on a computing device, such as a computer, server, phone, etc. and performs the primary function of receiving queried information (e.g. a domain name) and forwarding a location in response (e.g. an IP address).

A DNS resolver is a DNS server which receives a domain name lookup request (i.e. DNS query) from a client device. The DNS resolver determines a corresponding IP address by sending one or more additional DNS queries to one or more separate DNS servers often referred to as name servers. The name servers may respond with DNS responses containing additional lookup information, which might point to another DNS name server or the queried IP address. Once the DNS resolver determines the IP address that corresponds to the client device's queried domain name, the DNS resolver forwards a DNS response, containing the IP address, to the original client device.

A network's DNS can be comprised of a variety of different configurations of one or more DNS servers. Furthermore, there are a large number of different software implementations for a single DNS server. Examples of DNS software implementations include PowerDNS, BIND9, MaraDNS, etc. Networks may even deploy proprietary DNS software implementations.

DNS is critical to the function of networks. However, DNS has loose restrictions and by design, DNS resolvers are often accessible by any device (i.e. public). DNS servers expect valid network traffic (e.g. DNS queries, DNS responses, DNS requests, etc.) but this is not always guaranteed. Furthermore, DNS is an inherently stateful system, meaning the system's behavior depends on the inputs it receives (e.g. caching behavior).

When a DNS server does not carefully validate and sanitize network packets before processing them, a malformed network packet can exploit vulnerabilities in a DNS system and potentially lead to various attacks on the DNS system, the network, one or more client devices which access the DNS resolver, etc.

In one exploit, a malicious party can forward a malformed DNS query to the DNS resolver while imitating a legitimate client device. In another exploit, a malicious party can infiltrate or imitate a specific name server, making it a malicious name server. The malicious party can infiltrate a name server by publishing a malicious DNS record. The malicious party can then cause a DNS resolver to query the malicious name server, thus forwarding a malicious packet to the DNS resolver.

A malicious party may attack a DNS resolver as a client device, a name server, or both. DNS attacks may include Denial of Service (DoS), DNS poisoning, and service downgrading, etc.

The vulnerabilities affecting different DNS systems are variable due to the variability of DNS implementations (e.g. a DNS resolver's software implementation). Therefore, a malformed packet may exploit one DNS system while being harmless to another DNS system. This property can be leveraged to detect malicious packets and block detected malicious packets before they are received by a DNS resolver that is in production.

The systems and methods disclosed herein enable a network to respond and prevent DNS related attacks in real time. A data collector is deployed alongside a network's DNS resolver. The data collector obtains some or all DNS traffic data that involves the DNS resolver, including the DNS traffic forwarded by the DNS resolver and the DNS traffic received by the DNS resolver (e.g. DNS queries, DNS responses, DNS requests, etc.).

The data collector may also collect metadata associated with the traffic, such as temporal data when DNS traffic was initiated or identifying information about DNS traffic (e.g. source IP of the packet). The data collector forwards the DNS traffic data to one sandbox or a plurality of different sandboxes.

A sandbox receives DNS traffic data. A single sandbox represents a particular DNS implementation. A single sandbox contains a DNS resolver. Different sandboxes have different DNS implementations. In addition, each sandbox contains a component which performs the functions of a client device and a name server (NS) i.e. a client & NS stub.

DNS implementations may vary due to a DNS resolver's properties (e.g. software implementation, configuration, caching behavior, etc.).

After the sandbox receives the DNS traffic data, a DNS traffic exchange is simulated. The client & NS stub may forward the initial DNS packet to begin the simulation of the DNS traffic exchange with the sandbox's DNS resolver. As the simulation proceeds, the sandbox collects simulation data, (e.g. cache, logs, config, system usage, network traffic exchange, etc.).

Upon the completion of the simulation, the sandbox forwards the simulation data to a detector. The sandbox may also forward metadata associated with the simulation (e.g. source identifying information, temporal data, identification of DNS implementation, etc.).

The detector receives simulation data from the one sandbox or the plurality of different sandboxes. The detector analyzes the simulation data. The detector may identify anomalies in the simulation data of a single sandbox. The detector may also compare the simulation data of the plurality of different sandboxes. The detector may use the comparison of simulation data to identify anomalies. For example, the detector may detect an anomaly associated with a DNS traffic exchange when one sandbox's system usage is significantly higher than that of other sandbox's which ran the same simulation.

After analyzing the simulation data from one sandbox or the plurality of different sandboxes and identifying anomalies, the detector forwards anomaly information. The detector may also forward metadata associated with the simulation. For example, the detector may alert a network provider that a certain DNS packet resulted in an anomaly. In response to receiving this information, security measures can be implemented to protect the network from related future attacks. Security measures may consist of any method to secure a network from malicious activity (e.g. implementing policies on a firewall, blocking network traffic from a particular source, blocking network traffic based on an analysis of the network traffic, issuing an alert to a network administrator warning of a certain attack, etc.).

The systems and methods disclosed herein are scalable. The method supports detection across various resolver implementations, sandboxes can run in parallel, additional sandboxes can be added with new resolver implementations, and a number of networks can integrate their DNS resolvers with a single instance of a cluster of sandboxes and detectors (e.g. the data collector can be deployed alongside one or more DNS resolvers).

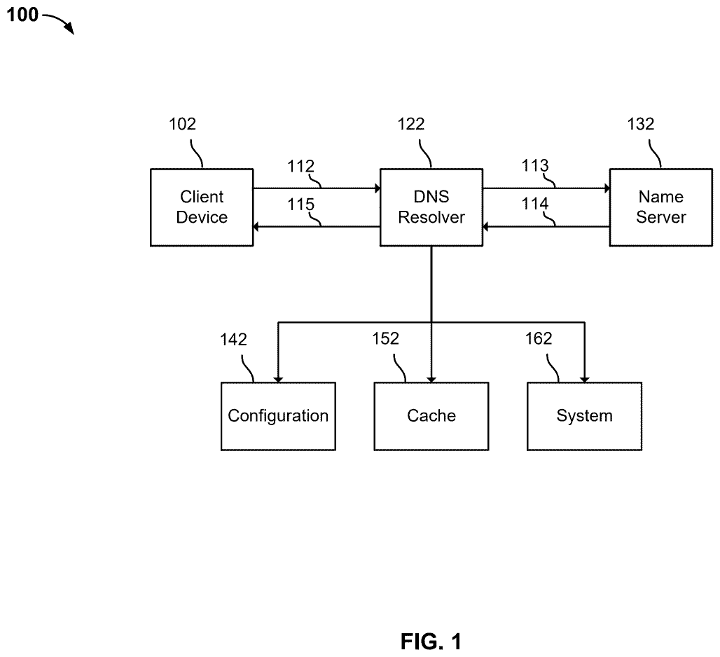

FIG. 1 is a system diagram illustrating a client utilizing a Domain Name Service (DNS). Components in system 100 may execute the DNS protocol. In some embodiments, client device 102 is any computing device which has access to DNS resolver 122 (e.g., laptop, server, desktop, computer, tablet, smart device, etc.). DNS query 112 can be initiated by a variety of entities including a human user, a computer running an automated script, etc. In some embodiments DNS resolver 122 is a DNS server on a private network.

In some embodiments, name server 132 represents one or more DNS servers which contain mappings of IP addresses, domain names, other DNS servers, etc. Although system 100 depicts only one name server 132, this is merely for illustrative purposes. DNS resolver 122 can be configured to exchange DNS traffic with one or more name servers. In some embodiments, name server 132 determines mapping information and forwards the mapping information in a DNS request 114 to DNS resolver 122.

Configuration 142, cache 152, and system 162 are components of DNS resolver 122. The components of DNS resolver 122 have vulnerabilities which can be exploited in an attack.

DNS resolver 122 receives DNS query 112 from client device 102 and executes a process to determine the corresponding IP address for the domain name. Upon receiving DNS query 112, DNS resolver 122 forwards a second DNS query 113 to one or more name server's 132. In response to determining the corresponding IP address for the domain name specified in DNS query 112, DNS resolver 122 forwards DNS response 115 to client device 102. DNS response 115 contains the corresponding IP address.

Information pertaining to DNS is referred to as a DNS record. DNS records are standard configurations which are used to store and communicate DNS related information, such as IP mappings. For example, an A record holds the IP address of a domain.

Other examples include the AAAA record, CNAME record, MX record, TXT record, NS record, SPA record, DNAME record, etc. Different types of DNS records may induce DNS servers to engage in different behaviors. For example, a DNAME record can induce a DNS resolver to redirect to an entire branch of a DNS hierarchy (e.g. a hierarchy of DNS servers) instead of just a single server.

This property is often leveraged in DNS attacks. For example, PowerDNS implementations can be compromised by exploiting a bug in the system's handling of DNAME records.

Client device 102 is any computing device which has access to DNS resolver 122 and the capability to forward and receive network packets such as DNS query 112 and DNS response 115. DNS resolver 122 can forward and receive network packets to one or a number of client devices.

Although system 100 depicts one client device 102, this is merely for illustrative purposes. System 100 can contain one or more client device 102s. One or more client device 102s can exchange network traffic with DNS resolver 122.

DNS query 112 can contain a query for any resource which is associated with an IP address, such as a server, File Transfer Protocol (FTP), a system, etc. The IP address may be IPv4, IPv6 or any implementation of IP address.

In some embodiments, client device 102 uses an application, such as a web browser, which queries an internal system, such client device 102's stub resolver to send DNS request 112. The stub resolver contains the IP address for one or more DNS resolvers 122. DNS resolver 122 is often public, meaning it is configured to accept incoming DNS queries 112 from any client device 102.

Client device 102 may structure DNS query 112 in a standard format determined by DNS protocol. Client device 102 may receive and handle DNS responses 115 which are structured in a standard format dictated by DNS protocol. Client device 102 is configured to forward DNS query 112, which contains the domain name of resource.

Standard DNS protocol is intentionally extensible. Therefore, different DNS implementations may implement standard DNS protocol with additional data types and software (e.g. BIND9, PowerDNS, MaraDNS, etc.) specific behaviors.

DNS query 112 may completely conform with standard DNS protocol or be modified in accordance with a particular DNS software implementation. DNS query 112 is a network packet which uses a particular communication protocol (e.g. UDP, TCP, etc.). In some embodiments, the network packet contains one or more layers. In some embodiments, one of layers in the network packet contains the queried domain name (e.g. the presentation layer).

Client device 102 is configured to receive DNS response 115 sent by DNS resolver 122. In some embodiments, DNS response 115 contains the IP address corresponding to the domain name in DNS query 112 (e.g. an A record). A stub service associated with client device 102 is configured to receive and process DNS response 115. Upon receipt of DNS response 115, the stub service can now provide an application implemented on client device 102's device with an IP address. The IP address is used client device 102's applications to exchange further network traffic with the resource corresponding to the IP address.

For example, suppose client device 102 is a user on a Personal Computer (PC) attempting to access a website on a web browser (i.e. the application). Upon entering the domain name of the website, the web browser will query the PC's stub service to send the domain name in the form of a DNS query (e.g. 112) to a DNS resolver (e.g. DNS resolver 122). The DNS resolver then exchanges DNS packets with one or more name servers, until a name server (e.g. name server 132) returns a DNS response that contains the IP address which corresponds to the domain name of the website.

At this point, the DNS resolver responds to the PC's stub service with the requested IP address in the form of a DNS response (e.g. DNS response 115). The PC's stub service then communicates this IP address with the client device's web browser. Now, the client device's web browser can exchange traffic directly with the IP address.

In some embodiments, client device 102's stub service contains the information that allows it to connect to one or more DNS resolvers 122 (e.g. the DNS resolver's IP address). In some embodiments, the stub service caches information gained from a query and a response.

Often there are no security measures to prevent malicious parties from imitating a legitimate client device 102. In some embodiments, a malicious party can configure any system, such as PC, phone, server, etc. with a stub resolver and the IP address of DNS resolver 122 to forward a malicious DNS query 112 to DNS resolver 122.

Referring back to the example, instead of a benign web browser, the malicious party may utilize a malicious application to send malicious DNS queries using the PC's stub service. In some embodiments, upon processing the malicious packet, DNS resolver 122 is attacked.

DNS resolver 122 is configured to receive DNS queries 112 from one of more client devices 102 and perform DNS lookups for the queried domain name. DNS resolver 122 may implement one of a plurality of different DNS software implementations e.g. BIND9, PowerDNS, MaraDNS etc. DNS resolver 122 may completely adhere to DNS protocol or include additional functionality according to its software implementation.

DNS resolvers are often designed to be public; this exposes the DNS resolver to threats from malicious client devices. DNS resolver 122 can be recursive, non-recursive, iterative, etc.

A recursive resolver will continue to forward and receive DNS queries and DNS responses with one or more name servers until it locates the corresponding IP address or determines that it cannot locate the IP address. In response to a determination that the DNS resolver cannot locate the IP address, it will return a DNS response containing an error to the client device. In response to a determination that the IP address has been located, it will forward a DNS response containing the IP address to the client device.

In contrast, a non-recursive DNS resolver receives the domain name and query's one name server with the domain name. The DNS resolver then responds to the client device by forwarding the name server's DNS response. Now, the client device performs another DNS query on either the same DNS resolver or a different DNS resolver and the process repeats until a DNS server returns the corresponding IP address.

Some attacks utilize the recursive nature of a DNS resolver. For example, a malicious party could induce the DNS resolver to attempt to recursively resolve an infinite number of times.

Upon receiving a DNS query 112, DNS resolver 122 unpacks the network packet using a procedure which corresponds to the transport layer communication protocol of the packet. Communication protocols include uniform datagram protocol (UDP), transfer control protocol (TCP), etc. In some embodiments, DNS resolver 122 exchanges network traffic with client devices over a specified port (i.e. port 53). In some embodiments DNS resolver 122, simultaneously communicates with client devices over one or more ports.

Malformed packets may utilize the vulnerabilities related to the communication protocol. Some attacks, such as DNS cache poisoning, utilize communications over one or more ports in addition to sending a malicious packet. In some embodiments, DNS resolver 122 unpacks the packet to access the queried domain name. Upon accessing the queried domain name, DNS resolver 122 initially queries cache 152 with the domain name. When cache 152 contains the corresponding IP address, DNS resolver 122 packages the IP address into a network packet using a communication protocol (i.e. UDP) and forwards the network packet to client device 102 as DNS response 115.

Sometimes cache 152 contains information corresponding to the domain name and facilitates locating a queried domain name's corresponding IP address (e.g. a SOA record). For example, cache 152 may contain the IP address of a name server that contains the queried domain name's corresponding IP address.

In response to a determination that cache 152 contains neither a DNS record for the domain name nor a DNS record for an intermediate IP, DNS resolver 122 forwards one or more queries to one or more DNS servers (e.g. name servers).

DNS resolver 122 receives one or more DNS responses 114 from one or more name servers 132. DNS response 114 may contain the corresponding IP address, a referral to a next name server (i.e. the IP address of a next server), or an error. The error may indicate that the IP address cannot be located. In some embodiments, if the response is either the corresponding IP address or an error, DNS resolver 122 immediately forwards the response to client device 102 in the form of DNS response 115.

In some embodiments, configuration 142 is information that is used to configure DNS resolver 122. Configuration 142 can distinguish the properties of DNS resolvers even between DNS resolvers in the same DNS implementations, which may expose the distinct networks to distinct vulnerabilities. In some embodiments, configuration 142 influences how DNS resolver 122 interacts with cache 152. Therefore, different configurations may expose DNS resolver 122 to different vulnerabilities.

System 162 provides DNS resolver 122 with the functionality and computing resources required for DNS resolution. System 162 can create and store logs of the activity of DNS resolver 122. For example, system 162 might create a log which describes the amount of computation power DNS resolver 122 is using over a certain period of time.

In some embodiments, malformed DNS packets corrupt the state of DNS resolver 122 (e.g. the cache and/or configuration). In some embodiments, malformed DNS packets corrupt the underlying system of DNS resolver 122. In some embodiments, malformed packets corrupt DNS query 113 (i.e. DNS request) sent by DNS resolver 122 to name server 132. In some embodiments, malformed packets corrupt DNS response 115 sent by DNS resolver 122 to client device 102.

Name server 132 receives DNS query 113, performs a lookup for the specified data in DNS query 113, and responds with DNS response 114. DNS response 114 may contain the queried information, intermediate information to facilitate finding the corresponding IP address, or an error.

In some embodiments, name server 132 represents one or more DNS servers which contain mappings of locations. Examples of locations include IP addresses, domain names, other DNS servers, etc. Name server 132 may be internal to the same network as DNS resolver 122 or external (e.g., authoritative name servers of the internet). In some embodiments, name server 132 responds to one or more DNS queries forwarded from DNS resolver 122 with one or more DNS responses.

Sometimes, a first name server 132 receives a DNS query 113, responds with the IP address of a second name server in DNS response 114, DNS resolver 122 forwards a request to the specified name server, etc. until a name server 132 responds with the IP address or with an error indicating the IP address does not exist. This process may occur in recursive DNS resolution.

Name server 132 can be public and accessible by any DNS resolver 122. For example, the internet's DNS system contains a number of top-level domains TLD name servers. Each name server contains additional lookup information for a certain top-level domain, such as .com, .edu, .gov etc. The internet's TLD name servers are publicly accessible.

On the internet, a TLD name server returns a record for the authoritative name server. The DNS resolver queries the specified authoritative name server. The authoritative name server responds with a DNS response which directs to the IP address of the client's original domain name.

Authoritative name servers can be created by anyone. Furthermore, anyone can create a DNS record on certain name servers.

A public name server (e.g. name server 132) can be configured to act on behalf of malicious parties. For example, a malicious party may create its own authoritative name server. In another example a name server may contain a DNS record that was created by a malicious party.

DNS resolver 122 can be induced to query a malicious name server 132 or query a specific malicious name server record. In some embodiments, upon querying a malicious name server or name server record, name server 132 responds with a malicious network packet as DNS response 114.

DNS systems can be vulnerable to a wide variety of attacks. DNS systems have a large attack surface because attacks are facilitated by exploiting vulnerabilities in a variety of aspects pertaining to the system's implementation. For example, DNAME related attacks exploit a DNS resolver's application of the DNAME rewriting rule, while cache poisoning attacks exploit a DNS resolver's caching system. Attacks may utilize one or more malformed network packets (e.g. DNS queries, DNS responses, DNS requests, etc.,) from one or more malicious sources (e.g. client devices, name servers, etc.).

Other examples of attacks include DNS resolver state corruption attacks (e.g. DNS cache poisoning), malformed name server response attacks (e.g. period injections), Denial of Service (DoS) attacks, DNS amplification, DNS spoofing, DNS tunneling, DNS hijacking, DNS reflection, DNS attacks using Domain Name Generation Algorithms (DGA), cryptojacking, DNS rebinding attacks, etc.

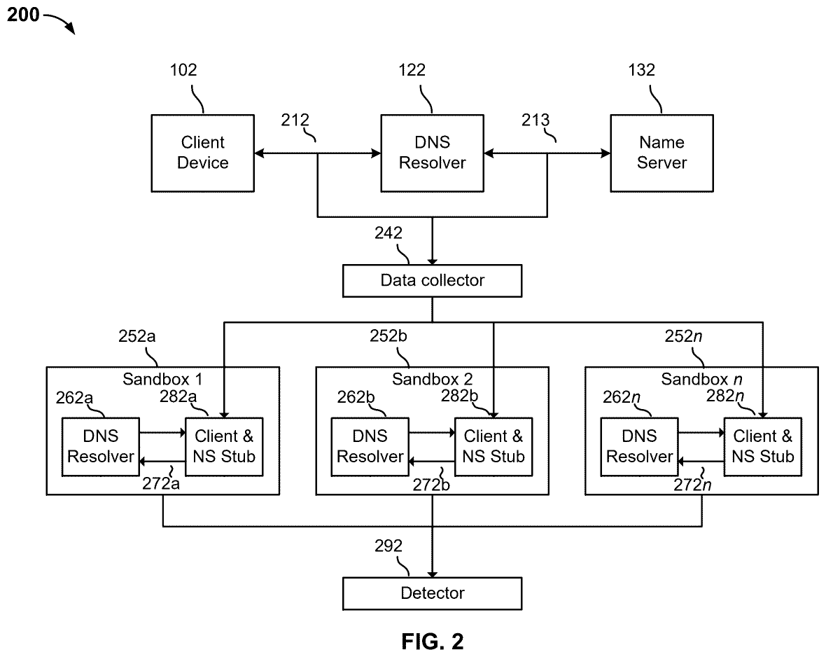

FIG. 2 is a block diagram of a system to implement DNS on a network with enhanced security capabilities in accordance with some embodiments. In the example shown, system 200 includes client device 102, DNS resolver 122, and name server 132 of system 100.

In the example shown, DNS client network traffic 212 corresponds to DNS query 112 and DNS response 115. DNS name server network traffic 213 corresponds to DNS query 113 and DNS response 114. In some embodiments, DNS resolver 122 may contain a configuration, cache, and system components similar to configuration 142, cache 152, and system 162, respectively.

In some embodiments, data collector 242 collects all DNS client network traffic 212 and all DNS name server network traffic 213.

In some embodiments, DNS resolver 122 is the DNS resolver for a private network. In some embodiments, client device 102 is part of the same network as DNS resolver 122. In some embodiments, name server 132 is one or more name servers. In some embodiments, some name servers 132 are part of the same network as DNS resolver 122 and some name servers 132 are part of a different network.

In some embodiments, client device 102 is a malicious party imitating a legitimate client device. In some embodiments, a malicious client device 102 is not part of the same network as DNS resolver 122. The malicious client device 102 may still be able to forward DNS queries into the network by utilizing a technique such as DNS rebinding. In some embodiments, client device 102 forwards a malicious DNS query to DNS resolver 122.

In some embodiments, the client device 102 is configured to receive a DNS response from DNS resolver 122 (e.g. as depicted by DNS client device traffic 212). In some embodiments, the DNS response may be a malformed packet or contain malicious content. In some embodiments, the DNS response is a result of an attack.

In some embodiments, DNS resolver 122 can act as both an internal DNS resolver which resolves queries for internal domains and an external DNS resolver which resolves queries for public domains, such as websites on the internet.

In some embodiments, DNS resolver 122 is part of a private network. DNS resolver 122 may implement any DNS software (e.g. PowerDNS, BIND9, MaraDNS, etc.). DNS resolver may be a recursive resolver, non-recursive resolver, iterative resolver etc.

In some embodiments, DNS resolver 122 is in production on a given network. In some embodiments, as DNS resolver 122 runs in production, data collector 242 simultaneously collects data from DNS resolver 122.

In some embodiments, name server 132 is part of the same network as DNS resolver 122. In some embodiments, name server 132 is part of a public DNS (e.g. the internet) while DNS resolver 122 is part of a private network. In some embodiments, name server 132 represents one or more name servers. Each name server may be public or private.

In some embodiments, data collector 242 is configured to collect the network traffic directed to DNS resolver 122 (i.e. DNS resolver 122 inputs). In some embodiments, data collector 242 forwards any collected network traffic to one or more sandboxes 252a, 252b, . . . , 252n.

Although system 200 only depicts three sandboxes 252a, 252b, and 252n, system 200 may contain 1: n sandboxes. In some embodiments, sandbox 252n is an isolated computing instance that contains DNS resolver 262n and client & NS stub 282n. In some embodiments, sandbox 252n simulates a DNS network traffic exchange forwarded (i.e. network traffic exchange 272n) from data collector 242. In some embodiments, each sandbox consists of a particular DNS implementation.

DNS implementations may vary due to a DNS resolver's properties (e.g. software implementation, configuration, caching behavior, etc.). In some embodiments, a particular DNS implementation is in a particular sandbox 252n (i.e. one implementation per sandbox 252n, where each sandbox 252a, 252b, . . . , 252n contains a different implementation).

In some embodiments, sandbox 252n forwards simulation data to detector 292. In some embodiments, detector 292 receives simulation data from one or more of a plurality of sandboxes 252a, 252b, . . . , 252n. In some embodiments, detector 292 is configured to detect DNS related attacks by analyzing the simulation data from a plurality of sandboxes 252a, 252b, 252n.

DNS related attacks can cause simulations associated with vulnerable DNS implementations to output anomalous simulation data. In some embodiments, detector 292 detects DNS related attacks by identifying anomalous simulation data.

For example, attacks involving infinite recursion can be detected by analyzing system usages. This is because infinite recursion may cause a vulnerable DNS system to exhibit anomalously high amounts of system usage as compared to DNS system's which are not vulnerable.

Often times, a network may exercise greater control over the process of resolving an internal domain. For example, an internal domain may be accessed when a company employee with secure access to a private company network is attempting to access an internal resource. The company employee queries an internal DNS resolver, and the company DNS resolver queries an internal company name server. In this example, all components are internal to the companies' network. Even with internal client devices, resolvers, and name servers, internal private networks may still be vulnerable to exploits by malicious parties through client devices or name servers.

In contrast, a network may have less control over the process of resolving an external domain. For example, a DNS resolver may resolve the domain name for a website. The process of resolving for the website may require contact with one or more external name servers, including authoritative name servers. Authoritative name servers can be created by anyone including malicious parties.

Private network DNS systems may have the ability to resolve internal domain names as well as external domain names.

In some embodiments, data collector 242 is implemented on a computing device that can receive, store, and process network traffic. Data collector 242 may run in parallel to client device 102, DNS resolver 122, and name server 132. In some embodiments, data collector 242 is configured to monitor and collect all network traffic exchanges that involve DNS resolver 122.

In some embodiments, data collector 242 is configured to collect inputs to DNS resolver 122. Inputs may include DNS responses from name server 132 and DNS queries from client device 102.

In some embodiments, data collector 242 collects DNS queries, DNS responses, DNS requests, etc. In some embodiments, DNS traffic data includes metadata relating to DNS network traffic (e.g. caching information, source, timing, size, etc.). Data collector 242 aggregates collected traffic data and metadata for future use. Data collector 242 forwards aggregated DNS traffic data to one or more of a plurality of sandboxes 252a, 252b, . . . , 252n.

Data collector 242 is configured to collect such that a network traffic exchange can be accurately and completely simulated. For example, suppose a network traffic exchange is facilitated by a DNS resolver's cache. Data collector 242 collects data such that a simulated DNS resolver acts in a like manner.

In some embodiments, data collector 242 aggregates data. Aggregating data may include labeling DNS traffic data with metadata such as identity of sources (e.g. DNS resolver, name server, and client device) involved, temporal data of collection, etc.,

Each of the plurality of sandboxes 252a, 252b, . . . , 252n is configured to receive DNS traffic data from data collector 242. A sandbox is configured to use a particular implementation of DNS and a client & NS stub 282n to simulate network traffic exchange 272n. Each DNS implementation may reflect a DNS resolvers' (e.g. DNS resolver 262n) properties such as software implementation, configuration, caching behavior, etc.

A sandbox 252 is configured to monitor any information associated with the simulation i.e. simulation data. Examples of simulation data include, cache, logs, config, system usage, contents of network traffic exchange (272a, 272b, 272n), etc. Simulation data can be used to detect anomalies and prevent attacks.

In some embodiments, client & NS stub 282a, 282b, . . . , 282n is configured to receive the DNS query which initiated a corresponding traffic exchange as collected by data collector 242. In some embodiments, a client & NS stub, such as client & NS stub 282n, acting as a client device, is configured to initiate a simulation by forwarding the initial DNS query to DNS resolver 262n.

The DNS system within each of the plurality of different sandboxes 252a, 252b, . . . , 252n has properties which may be different from those of which DNS resolver 122 is a component (e.g. software implementation, configuration, caching behavior, etc.). In some embodiments, upon receiving the initial DNS query, a DNS resolver, such as DNS resolver 262n, is configured to facilitate a simulated DNS resolution process with a client & NS stub, such as client & NS stub 282n.

In some embodiments, each of the plurality of DNS resolvers 262a, 262b, . . . , 262n is configured to simulate DNS behaviors (e.g. caching, resolving, etc.), such that the behavior is representative of how each of the plurality of DNS resolvers 262a, 262b, . . . , 262n would behave given the network traffic and the DNS implementation.

In some embodiments, a client & NS stub is configured to function as a name server which is used by a corresponding DNS resolver to simulate a DNS resolution process. In some embodiments, client & NS stub 282n and DNS resolver 262n simulate DNS traffic until DNS resolver 262n receives a corresponding IP address. In some embodiments, this causes the simulation to end.

A client & NS stub is configured to function as both a client (e.g. by sending DNS queries, receiving DNS responses, etc.) and a name server (e.g. by receiving DNS queries, sending DNS responses, etc.).

In some embodiments, a client & NS stub, such as client & NS stub 282n is configured to forward inputs to a corresponding DNS resolver, such as DNS resolver 262n, that correspond to the inputs provided by data collector 242, such that the network traffic from client & NS stub 282n to DNS resolver 262n (i.e. the inputs) is determined prior to the simulation.

For example, suppose data collector 242 forwards the DNS exchange of a recursive resolution. First, client & NS stub 282n, acting as a client device, forwards the initial DNS query to DNS resolver 262n. Client & NS stub 282n, acting as a name server, simulates the recursive resolution process by forwarding each input in the process, as collected by data collector 242.

In this example, the inputs into DNS resolver 122 are used to execute the simulation. DNS resolver inputs are used to execute the simulation and the outputs of DNS resolver 262n are collected as simulation data. The simulation may end when client & NS stub 282n forward's all DNS traffic corresponding to a DNS network exchange as collected by data collector 242. The DNS traffic consists of inputs for DNS resolver 262n, thus, once every input is received by DNS resolver 262n, the simulation is terminated.

In some embodiments, the inputs of client & NS stub 282n are affected by DNS resolver 262n's outputs, such that attacks which involve multiple DNS exchanges can be detected. In some embodiments, the outputs of DNS resolver 262n affect the simulation.

In some embodiments, similar to a real world DNS implementation, the simulation is terminated when client & NS stub 282n receives a domain name's corresponding IP address, a intermediate IP address, an error, etc.

In some embodiments, from the initiation of the simulation to the end of the simulation, the plurality of sandboxes 252a, 252b, . . . , 252n record and store all simulation data. In some embodiments, the plurality of sandboxes 252a, 252b, . . . , 252n forward the simulation data to detector 292.

Detector 292 is configured to receive simulation data from the plurality of sandboxes 252a, 252b, . . . , 252n. Detector 292 is implemented on a computing device that can receive, process, and send data. Detector 292 receives simulation data representing a plurality of simulations from the plurality of sandboxes 252a, 252b, . . . , 252n. Detector 292 may analyze simulation data in order to detect malicious activity, such as malicious packets. Detector 292 produces information that can be used to enhance a networks security against DNS related attacks. In some embodiments, security measures are implemented on network traffic. Security measures may include blocking DNS packets that are malformed from accessing a DNS resolver. Security measures may include blocking network traffic from a source-IP address that sends malicious packets. For example, a network firewall may be configured to block traffic from a source-IP address.

Detector 292 is configured to collect the states and outputs of all resolver implementations in the sandboxes 252a, 252b, . . . , 252n. By comparing the data from all of the sandboxes, malformed DNS packages are captured when the states or outputs are inconsistent across the different resolver implementations.

In some embodiments, detector 292 is configured to analyze simulation data by comparing the simulation data associated with simulations which use the same inputs i.e. the same DNS traffic (e.g. DNS queries, DNS responses, DNS requests, etc.). In some embodiments, malicious activity is detected when there are one or more instances of anomalous simulation data.

For example, suppose client device 102 forwards a DNS query to DNS resolver 122 and initiates DNS Exchange A. DNS Exchange A is collected by data collector 242 in the form of DNS traffic. DNS Exchange A is forwarded to the plurality of sandboxes 252a, 252b, . . . , 252n. Each sandbox uses the DNS traffic to simulate DNS Exchange A, with a different DNS implementation. For example, DNS resolver 262a may implement BIND9, DNS resolver 262b may implement PowerDNS,. DNS resolver 262n may implement MaraDNS. At the end of each simulation, sandboxes 252a, 252b, . . . , 252n produce corresponding Exchange A Simulation Data 252a, 252b, . . . , 252n which is forwarded to detector 292. Detector 292 may analyze DNS Exchange A by comparing the corresponding Exchange A Simulation Data 252a, 252b, . . . , 252n.

Now, detector 292 can determine if DNS Exchange A contains malicious packets by searching for anomalous instances of the corresponding Exchange A Simulation Data252a, 252b, . . . , 252n. For example, suppose Exchange A Simulation Data 2 from Sandbox 252b indicates that the simulation used an anomalous amount of CPU or memory usage. This could be indicative of a variety of different DNS attacks including a DNS amplification attack, DoS attack, etc.

Detector 292 can now send an alert indicating that DNS Exchange A engages in malicious activity (e.g. it contains malicious packets, it involves a malicious client device, involves a malicious name server, involves a malicious DNS record, etc.). In some embodiments, the alert is received by a network. In response to receiving an alert, a network may implement security measures.

In some embodiments, one or more malicious packets are inputs from a particular name server 132. In some embodiments, one or more malicious packets are inputs from a particular client device 102. Source information gathered by data collector 242 can be used to block particular sources from accessing DNS resolver 122, thus enhancing the future security of the network.

When a resolver receives an attack that manipulates its requests to name servers or its responses to clients, differences in the outputs between vulnerable and non-vulnerable sandbox implementations are observed. For example, when receiving a self-referential DNAM record from a name server, detector 292 can capture a vulnerable resolver returning an abnormally large DNS response, while a resistant resolver's response is much smaller.

Any amount of simulation data produced by one or more sandboxes 252a, 252b, . . . , 252n can be used to produce information that is useful in detecting malicious activity. Any simulation data including cache, logs, config, system usage, contents of network traffic exchange 272n, etc. can be used to identify anomalies. A vulnerable resolver will have abnormal changes in its cache or configuration. Information produced by detector 292 can be used in any way to enhance a networks security against DNS related attacks. For example, a network may implement security measures. Security measures may consist of any method to secure a network from malicious activity (e.g. implementing policies on a firewall, blocking network traffic from a particular source, blocking network traffic based on an analysis of the network traffic, issuing an alert to a network administrator warning of a certain attack, etc.).

In some embodiments, information generated by detector 292 is used to modify a network firewall which protects DNS resolver 122. In some embodiments, information generated by detector 292 is used to detect and protect from malicious packets on the fly.

As an illustration, suppose detector 292 detects that a malicious name server forwarded a malicious DNS response to DNS resolver 122. Once detector 292 determines that the DNS response is malicious, it can immediately alert the network of the malicious name server. In response the network can immediately block the malicious name server's access to DNS resolver 122.

In some embodiments, DNS network traffic (e.g. 212 and 213) can be controlled by a firewall protecting DNS resolver 122, such that malformed packets can be blocked from interacting with DNS resolver 122. For example, external name servers that are discovered to be attacker owned or determined to contain malicious DNS records can be blocked from interacting with components internal to the network (e.g. DNS resolver 122). In another example, external malicious clients can be blocked access, once it is determined that they are engaging in malicious activity.

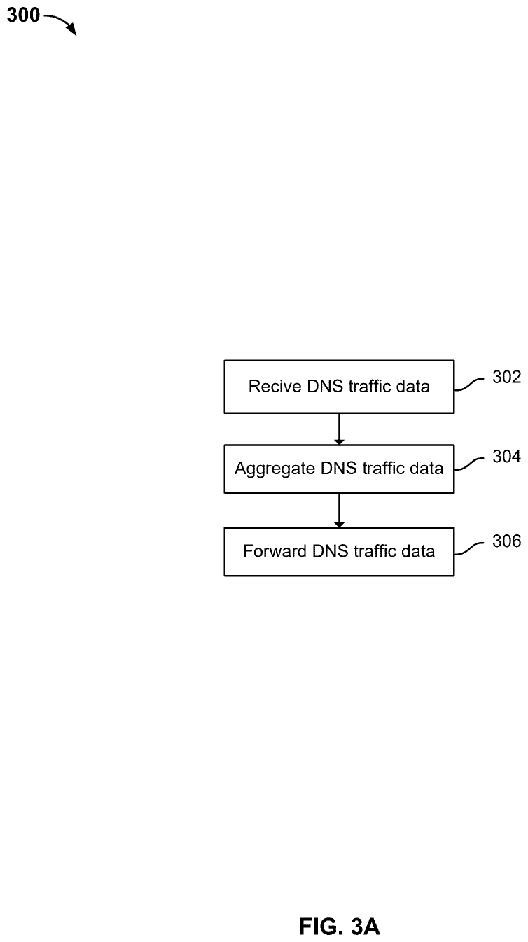

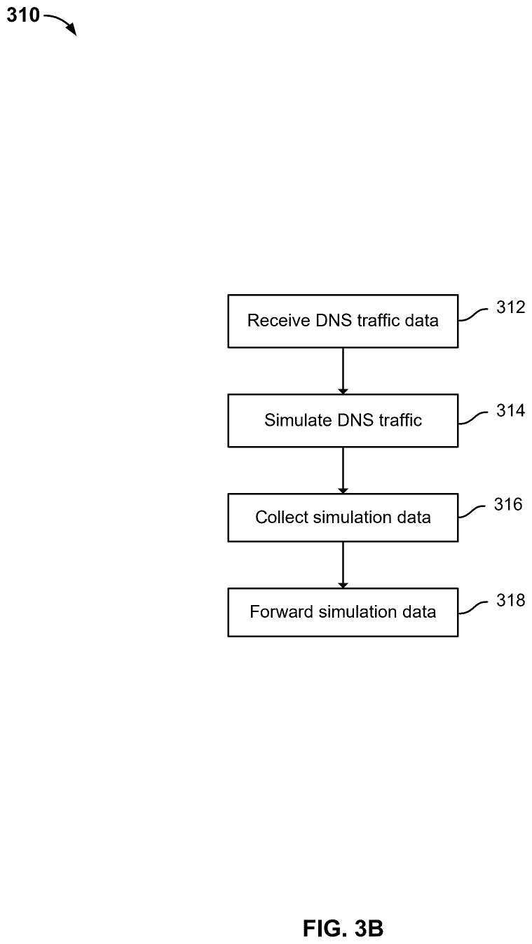

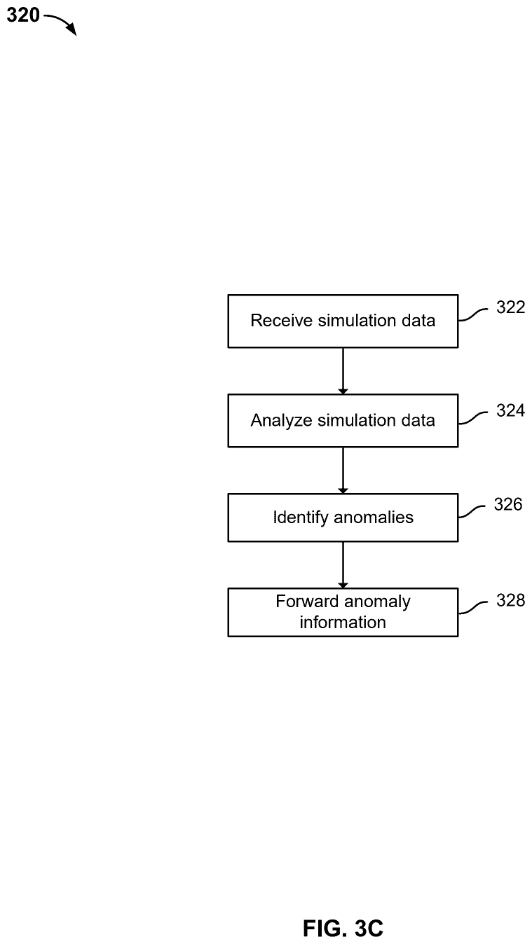

FIG. 3A is a flow diagram illustrating a process to collect real world DNS traffic data for future use in accordance with some embodiments. In some embodiments, process 300 is implemented by a data collector, such as data collector 242.

At 302, DNS traffic data associated with the target DNS resolver is received. The DNS traffic data consists of DNS client network traffic (e.g. DNS client network traffic 212) and DNS name server network traffic (e.g. DNS name server network traffic 132). This includes DNS queries, DNS responses, DNS requests, etc. In some embodiments, a device executing the process receives or generates metadata associated with DNS traffic (e.g. caching information, source, timing, size, etc.).

At 304, DNS traffic data and metadata is aggregated. This enables DNS traffic exchanges to be simulated and traced back to the real world DNS traffic exchange (e.g. by labeling each exchange with some metadata, so that each simulation can be traced back to the original DNS traffic exchange).

At 306, the DNS traffic data is forwarded. The aggregated DNS traffic data is forwarded to a single sandbox or a plurality of different sandboxes.

FIG. 3B is a flow diagram illustrating a process to simulate DNS traffic data in accordance with some embodiments. Process 310 may be implemented by a sandbox, such as sandboxes 252a, 252b, . . . , 252n.

At 312, DNS traffic data is received. DNS traffic data may include one or more exchanges of DNS traffic. For example, a DNS traffic exchange may include the DNS traffic that is exchanged between a client device, a DNS resolver, and a name server name server in the process of resolving a domain name and forwarding it to a client device. DNS traffic data includes DNS query, DNS responses, DNS requests, etc.

In some embodiments, a DNS traffic exchange includes inputs to a DNS resolver.

At 314, the DNS traffic data is simulated. In some embodiments, the DNS traffic data is simulated using a DNS resolver and a client & NS stub. In some embodiments, the simulated DNS system is different than that of the real world DNS system from which the DNS traffic data originated. In some embodiments, the DNS resolver is simulated using one or more different DNS systems (e.g. PowerDNS, BIND9, MaraDNS, etc.).

At 316, simulation data is collected. The simulation data may be collected during or at the end of the simulation. Simulation data may include, cache, logs, config, system usage, contents of DNS traffic exchange, etc.

In some embodiments, the DNS traffic exchange is simulated by replaying the exchange (e.g. sending and receiving each DNS packet as occurred in the real world). In some embodiments, one or more network packets from the real world DNS traffic exchange is modified according to the particular DNS system implementation of the device implementing the process.

In some embodiments, the simulation includes the simulated client device and name server sending inputs to the simulated DNS resolver. In some embodiments, one or more outputs of the simulated DNS resolver are different than those of the real world DNS resolver, reflecting a difference in DNS implementation.

In some embodiments, one or more inputs to the simulated DNS resolver are different than those of the real world because the outputs of the DNS resolver or configuration of other components effect the simulation.

In some embodiments, metadata associated with the simulation is collected such that the simulation can be linked to the real world DNS traffic exchange. In some embodiments, other metadata such as time the simulation took place and the DNS system implementation identification is collected.

At 318, the simulation data is forwarded. Any data that resulted from the simulation may be forwarded at this step. In some embodiments, metadata is forwarded at this step as well. In some embodiments, the simulation data is forwarded to a device executing the process illustrated in FIG. 3C.

FIG. 3C is a flow diagram illustrating a process to enhance DNS security in accordance with some embodiments. Process 320 may be implemented by a detector, such as detector 292.

At 322, simulation data is received. The simulation data may include metadata. The simulation data is received from one or more sandboxes, each sandbox implementing a different type of DNS implementation.

At 324, the simulation data is analyzed. Analysis may include any process which can be used to gain insights into a set of data. In some embodiments, malicious activity is detected based on the analysis.

In some embodiments, simulation data which represents the same DNS traffic exchange, and a different DNS system implementation is compared. Any simulation data can be compared (e.g. cache comparison, logs comparison, config comparison, system usage comparison, contents of simulated network traffic exchange comparison, etc.). Any set of data can be compared to any other set of data.

In some embodiments, every set of simulated data associated with the same simulated exchange is compared.

At step 326, one or more anomalies are identified. In some embodiments, a particular set of simulation data may contain a data point that is anomalous (e.g. system usage exceeds a threshold delta value as compared to that of other simulations). In some embodiments, an anomaly indicates that the original DNS traffic exchange involved malicious activity (e.g. contained a malicious packet).

In some embodiments, an anomaly indicates that malicious activity was involved in the original traffic exchange. In some embodiments, the malicious activity only causes an attack on one or more implementations of a DNS system. Thus, an analysis of the results of a plurality of simulations with different DNS system implementations, is able to identify malicious activity where a previous detection system could not.

In some embodiments, the analysis is used to identify malicious parties (e.g. name servers, client devices, etc.,), and/or identifying features of malicious packets. For example, a device executing the process, may use the metadata to identify a source of a malicious packet. In some embodiments, identifying features of malicious packets may be extracted from the simulation data.

In some embodiments, the analysis produces information associated with anomalies (i.e. anomaly information). In some embodiments, information associated with an anomaly is useful in preventing DNS related attacks on a network.

At 328, anomaly information is forwarded. In some embodiments, the anomaly information is forwarded to an entity which is able to use the information to enhance network security. For example, information associated with an anomaly may be used to implement security measures.

For example, the anomaly may be forwarded to a network firewall. The network firewall can use source information associated with anomalous activities to block malicious parties (e.g. malicious client devices, malicious name servers, etc.). In another example, the network firewall may use identifying information of malicious packets to identify and block malicious network packets which attempt to access the network. The anomaly information can be used in any manner to secure the network.

In some embodiments, the anomaly information can be used to detect security threats on the fly. This is because a system executing processes 300, 310, and 320 is running simultaneously with an in production (i.e. real world) DNS system. Thus, at the moment a security threat is detected, the real world system can detect and prevent the threat.

Although the foregoing embodiments have been described in some detail for purposes of clarity of understanding, the invention is not limited to the details provided. There are many alternative ways of implementing the invention. The disclosed embodiments are illustrative and not restrictive.

1. A method, comprising:
collecting network traffic associated with a domain name service (DNS) resolver;
simulating network traffic using a plurality of different sandboxed DNS resolvers; and
detecting a DNS-related attack on the DNS resolver based on corresponding outputs associated with the plurality of different sandboxed DNS resolvers.

2. The method of claim 1, wherein the network traffic is one or more DNS queries and/or DNS responses.

3. The method of claim 1, wherein security measures are implemented with respect to subsequent network traffic matching the network traffic in response to detecting the DNS-related attack on the DNS resolver.

4. The method of claim 1, wherein detecting the DNS-related attack on the DNS resolver includes identifying anomalies based on corresponding outputs associated with the plurality of different sandboxed DNS resolvers.

5. The method of claim 4, wherein detecting the DNS-related attack on the DNS resolver further includes forwarding the identified anomalies.

6. The method of claim 4, wherein a corresponding output is one or more caches.

7. The method of claim 4, wherein a corresponding output is one or more logs.

8. The method of claim 4, wherein a corresponding output is one or more configs.

9. The method of claim 4, wherein a corresponding output is system usage.

10. The method of claim 4, wherein a corresponding output is the contents of the simulated network traffic exchange.

11. The method of claim 1, wherein the plurality of different sandboxed DNS resolvers simulate the network traffic utilizing one or more of a client and a name server.

12. A system, comprising:
a processor configured to:
collect network traffic associated with a domain name service (DNS) resolver;
simulate network traffic using a plurality of different sandboxed DNS resolvers; and
detect a DNS-related attack on the DNS resolver based on corresponding outputs associated with the plurality of different sandboxed DNS resolvers.
a memory coupled to the processor and configured to provide the processor with instructions.

13. The system of claim 12, wherein security measures are implemented with respect to subsequent network traffic matching the network traffic in response to detecting the DNS-related attack on the DNS resolver.

14. The system of claim 12, wherein the processor is further configured to identify anomalies based on corresponding outputs associated with the plurality of different sandboxed DNS resolvers.

15. The system of claim 16, wherein detecting the DNS-related attack on the DNS resolver further includes forwarding the identified anomalies.

16. The system of claim 16, wherein a corresponding output is one or more logs.

17. The system of claim 16, wherein a corresponding output is one or more caches.

18. The system of claim 16, wherein a corresponding output is system usage.

19. The system of claim 12, wherein the plurality of different sandboxed DNS resolvers simulate the network traffic utilizing one or more of a client and a name server.

20. A computer program product embodied in a non-transitory computer readable medium and comprising computer instructions for:
collecting network traffic associated with a domain name service (DNS) resolver;
simulating network traffic using a plurality of different sandboxed DNS resolvers; and
detecting a DNS-related attack on the DNS resolver based on corresponding outputs associated with the plurality of different sandboxed DNS resolvers.
